(19) United States
(12) Patent Application Publication
(10) Pub. No.: US 2025/0358752 A1
(43) Pub. Date: Nov. 20, 2025

(54) S_SSB FREQUENCY HOPPING FOR ROBUST SIDELINK IN CONTESTED AND CONGESTED ENVIRONMENTS

(71) Applicant: INTERDIGITAL PATENT HOLDINGS, INC., Wilmington, DE (US)

(72) Inventors: Joe Huang, Montville, NJ (US); Sudhir Pattar, Mount Laurel, NJ (US); Phillip Leithead, King of Prussia, PA (US); Daniel Steinbach, Commack, NY (US)

(73) Assignee: INTERDIGITAL PATENT HOLDINGS, INC., Wilmington, DE (US)

(21) Appl. No.: 18/666,437

(22) Filed: May 16, 2024

(51) Int. Cl. H04W 56/00; H04W 16/28; H04W 92/18

(52) U.S. Cl. CPC H04W 56/0015; H04W 16/28; H04W 92/18

(57) ABSTRACT

Methods are described for ensuring robust S-SS/PSBCH blocks (S-SSBs) reception on the sidelink in the presence of high-power narrowband interference include frequency hopped S-SSB transmission to mitigate high-power narrowband interference such that if one frequency location of S-SSBs is corrupted by the high-power narrowband interference, the other frequency location(s) of the S-SSBs may not be affected.

### BACKGROUND

Sidelink synchronization signals (S-SS/PSBCH blocks or S-SSBs) and related master information block (MIB) are critical for wireless transmit/receive units (WTRUs) to perform synchronization procedures on a sidelink connection. In embodiments, corrupted S-SS/PSBCH blocks due to overlapping high-power narrowband interferers (e.g., in some spectrum sharing scenarios or due to an intentional jammer) in time and frequency domains should be avoided or mitigated in wireless sidelink communications.

In embodiments, a single sidelink bandwidth part (SL BWP) per cell is allowed. Each cell may be associated to only one set of S-SS/PSBCH blocks. In general, the bandwidth of the S-SS/PSBCH blocks (11 RBs) are narrower compared to the overall SL BWP bandwidth. When a narrow-band high power interferer lends itself onto the frequency locations where S-SS/PSBCH blocks transmit, the neighboring WTRUs may not be able to detect the synchronization signals for sidelink communications due to high level of interference.

### SUMMARY

Methods performed by a WTRU are described. A method performed by a WTRU may include: receiving configuration information comprising at least a first frequency for a first sidelink synchronization signal/physical sidelink broadcast channel (S-SS/PSBCH) transmission and a second frequency for a second S-SS/PSBCH transmission; monitoring for reception of the first S-SS/PSBCH transmission on the first frequency at a first time; and monitoring for reception of the second S-SS/PSBCH transmission on the second frequency at a second time. Additionally/alternatively method may include wherein the configuration information is received during a Radio Resource Control configuration or a system information message. Additionally/alternatively method may include wherein the first time and the second time are within a single S-SSB transmission period. Additionally/alternatively method may include wherein the first time and the second time occur during sequential S-SSB transmission periods.

A method performed by a WTRU may include receiving a configuration comprising at least a first frequency for a first S-SS/PSBCH transmission and a second frequency for a second S-SS/PSBCH transmission; transmitting a first S-SS/PSBCH transmission on the first frequency at a first time; and transmitting the second S-SS/PSBCH transmission on the second frequency at a second time. Additionally/alternatively method may include wherein the configuration information is received during a Radio Resource Control configuration or a system information message. Additionally/alternatively method may include wherein the first time and the second time are within a single S-SSB transmission period. Additionally/alternatively method may include wherein the first time and the second time occur during sequential S-SSB transmission periods. Additionally/alternatively method may include wherein the WTRU performs beam sweeping comprising a plurality of beam directions and wherein the first S-SS/PSBCH transmission and the second S-SS/PSBCH transmission are made in a first beam direction, and every subsequent two S-SS/PSBCH transmissions are made in the first and second frequencies per each of the remaining beam directions within a beam sweep. Additionally/alternatively method may include wherein the WTRU performs beam sweeping comprising a plurality of beam directions and wherein the first S-SS/PSBCH transmission is made in a first set of the beam directions of a first sweep through the plurality of beam directions and wherein the second S-SS/PSBCH transmission is made in a second set of beam directions of the first sweep through the plurality of beam directions. Additionally/alternatively method may include wherein the WTRU performs beam sweeping comprising a plurality of beam directions and wherein the first S-SS/PSBCH transmission is made at each of the beam directions of a first set of sweeps through the plurality of beam directions and wherein the second S-SS/PSBCH transmission is made at each of the beam directions of a second set of sweeps through the plurality of beam directions.

A WTRU may include: a processor and a transceiver, wherein the processor is configured to receive configuration information comprising at least a first frequency for a first S-SS/PSBCH transmission and a second frequency for a second S-SS/PSBCH transmission. Additionally/alternatively the WTRU may include wherein the transceiver is configured to monitor for reception of the first S-SS/PSBCH transmission on the first frequency at a first time, and to monitor for reception of the second S-SS/PSBCH transmission on the second frequency at a second time. Additionally/alternatively the WTRU may include wherein the first time and the second time are within a single S-SSB transmission period. Additionally/alternatively the WTRU may include wherein the first time and the second time occur during sequential S-SSB transmission periods. Additionally/alternatively the WTRU may include wherein the transceiver is configured to transmit the first S-SS/PSBCH transmission on the first frequency at a first time, and to transmit the second S-SS/PSBCH transmission on the second frequency at a second time. Additionally/alternatively the WTRU may include wherein the first time and the second time are within a single S-SSB transmission period. Additionally/alternatively the WTRU may include wherein the first time and the second time occur during sequential S-SSB transmission periods. Additionally/alternatively the WTRU may include wherein the transceiver is configured to perform beam sweeping comprising a plurality of beam directions and the transceiver is further configured to perform the first S-SS/PSBCH transmission and the second S-SS/PSBCH transmission in a first beam direction, and every subsequent two S-SS/PSBCH transmissions are made in the first and second frequencies per each of the remaining beam directions within a beam sweep. Additionally/alternatively the WTRU may include wherein the transceiver is configured to perform beam sweeping comprising a plurality of beam directions and the transceiver is further configured to perform the first S-SS/PSBCH transmission in a first set of the beam directions of a first sweep through the plurality of beam directions and to perform the second S-SS/PSBCH transmission is made in a second set of beam directions of the first sweep through the plurality of beam directions. Additionally/alternatively the WTRU may include wherein the transceiver is configured to perform beam sweeping comprising a plurality of beam directions and wherein the transceiver is further configured to perform the first S-SS/PSBCH transmission in each of the beam directions of a first set of sweeps through the plurality of beam directions and to perform the second S-SS/PSBCH transmission in each of the beam directions of a second set of sweeps through the plurality of beam directions.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an exemplary configuration for an information block;

FIG. 3A is an exemplary configuration for a bandwidth part;

FIG. 3B is an exemplary configuration for a bandwidth part;

FIG. 3C is an exemplary configuration for a bandwidth part;

FIG. 4A is an exemplary configuration including a frequency location;

FIG. 4B is an exemplary configuration including a frequency location;

FIG. 5A is an exemplary configuration for a system information block;

FIG. 5B is an exemplary configuration for a maximum number of carrier frequencies for sidelink communication;

FIG. 6A is an exemplary sidelink configuration;

FIG. 6B is a continuation of the exemplary sidelink configuration of FIG. 6A;

FIG. 7 is an exemplary configuration for sidelink synchronization;

FIG. 8A is an exemplary configuration for sidelink frequency configuration;

FIG. 8B is an exemplary flow diagram for sidelink frequency configuration;

FIG. 9 is a flow chart for an exemplary process for reception of S-SS/PSBCH;

FIG. 10 is a flow chart for an exemplary process for transmission of S-SS/PSBCH;

FIG. 11 is a flow chart for a further exemplary process for transmission of S-SS/PSBCH;

FIG. 12 is a flow chart for a further exemplary process for transmission of S-SS/PSBCH; and

FIG. 13 is a flow chart for a further exemplary process for transmission of S-SS/PSBCH.

### DETAILED DESCRIPTION

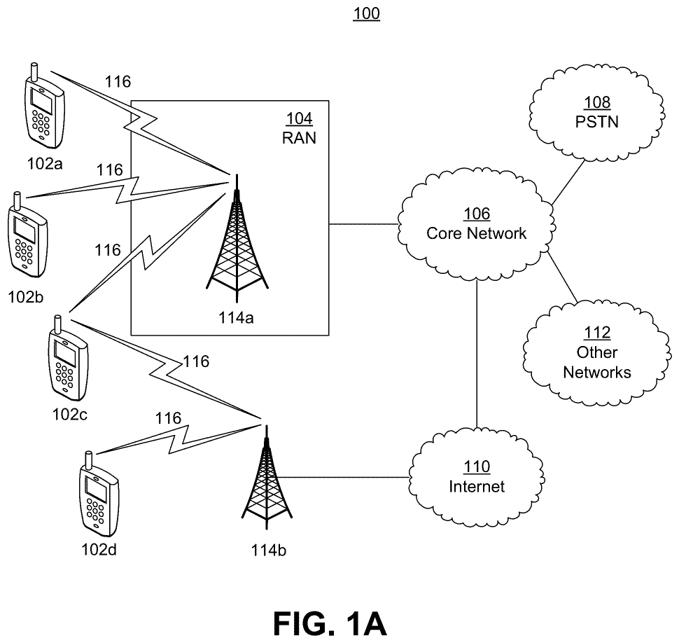

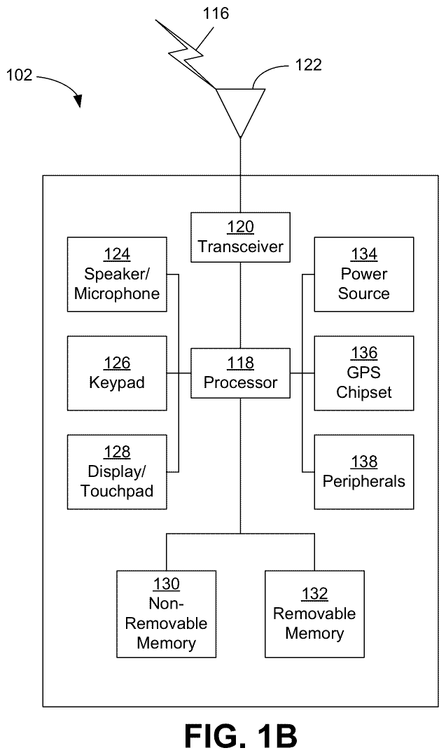

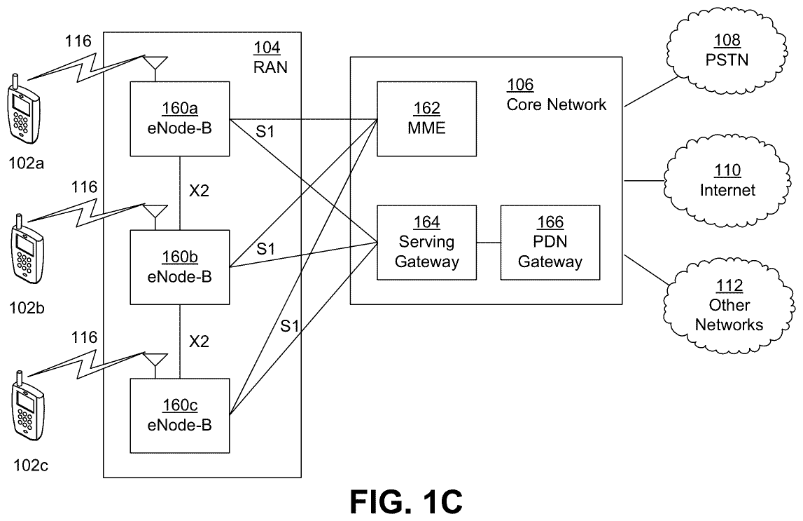

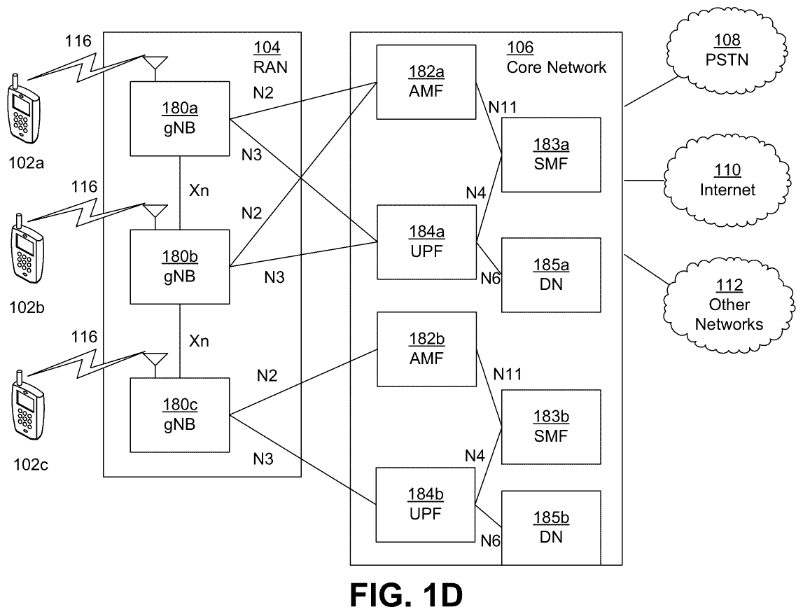

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHZ, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms are used interchangeably throughout this written description.
3GPP Third Generation Partnership Project
5G 5th Generation
ACK Acknowledgement
AoA Angle of Arrival
AoD Angle of Departure
ARFCN Absolute Radio-Frequency Channel Number
BLER Block Error Rate
BW Bandwidth
BWP Bandwidth Part
CAP Channel Access Priority
CAPC Channel access priority class
CCA Clear Channel Assessment
CCE Control Channel Element
CE Control Element
CG Configured Grant or Cell Group
CORESET Control Resource Set
CP Cyclic Prefix
CP-OFDM Conventional OFDM (relying on cyclic prefix)
CQ Channel Quality Indicator
CRC Cyclic Redundancy Check
CSI Channel State Information
CW Contention Window
CWS Contention Window Size
CO Channel Occupancy
CRB0 Common Resource block 0
DAI Downlink Assignment Index
DCI Downlink Control Information
DFI Downlink feedback information
DFN Direct Frame Number
DG Dynamic grant
DL Downlink
DM-RS Demodulation Reference Signal
DRB Data Radio Bearer
DRX Discontinuous Reception
ECID Enhanced Cell ID
elea enhanced Licensed Assisted Access
ebb enhanced Mobile Broadband
ENSURED-5G Enhanced Security and Co-Existence for DoD-5G
FeLAA Further enhanced Licensed Assisted Access
FR1 Frequency Range 1
FT Fourier Transform
gNB Next Generation (5G) NodeB
GNSS Global Navigation Satellite System
GPS Global Positioning System
GSCN Global Synchronization Channel Number
HARQ Hybrid Automatic Repeat Request
IM Interference Measurement
LAA License Assisted Access
LBT Listen Before Talk
LCH Logical Channel
LCP Logical Channel Priority
LBT Listen-Before-Talk
LOS Line of Sight
NLOS Non-Line of Sight
LMF Location Management Function
LPP LTE Positioning Protocol
LTE Long Term Evolution e.g., from 3GPP LTE R8 and up
MAC CE MAC Control Element
MAC Medium Access Control
MCS Modulation and Coding Scheme
MIB Master Information Block
MIMO Multiple Input Multiple Output
NACK Negative ACK
NAS Non-access stratum
NR New Radio
OFDM Orthogonal Frequency-Division Multiplexing
OTDOA Observed Time Difference of Arrival
PDCCH Physical Downlink Control Channel
PDSCH Physical Downlink Shared Channel
PDU Packet Data Unit
PHY Physical Layer
PID Process ID
PO Paging Occasion
PRACH Physical Random Access Channel
PRS Positioning Reference Signal
PSBCH Physical Sidelink Broadcast Channel
PRU Positioning Reference Unit
PSD Power Spectral Density
PSS Primary Synchronization Signal
PTRS Phase Tracking Reference Signal
PUCCH Physical Uplink Control Channel
PUSCH Physical Uplink Shared Channel
RA Random Access (or procedure)
RACH Random Access Channel
RAR Random Access Response
RB: Resource Block (12 RE's over a symbol duration)
RCU Radio access network Central Unit
RE Resource Element
RF Radio Frequency
RIS Reflective Intelligent Surface
RLF Radio Link Failure
RLM Radio Link Monitoring
RNTI Radio Network Identifier
RNA RAN Notification Area
RO RACH occasion
RRC Radio Resource Control
RRM Radio Resource Management
RTT Round Trip Time
RP Reception Point
RS Reference Signal
RSRP Reference Signal Received Power
RSTD Reference Signal Time Difference
RTT Round Trip Time
RSSI Received Signal Strength Indicator
RTOA Relative Time of Arrival
SCS Subcarrier Spacing
SFN System Frame Number
SI System Information
SIB12 System Information Block 12
SDAP Service data adaptation protocol
SDU Service Data Unit
SL Sidelink
SL-BCH Sidelink Broadcast Channel
S-PSS Sidelink Primary Synchronization Signal
SRB Signaling Radio Bearer
SRS Sounding Reference Signal
SS Synchronization Signal
SSS Secondary Synchronization Signal
S-SSB Sidelink Synchronization Signal Burst
SS_PBCH Synchronization and Broadcast Channel combination
S-SSS Sidelink Secondary Synchronization Signal
SWG Switching Gap (in a self-contained subframe)
SPS Semi-persistent scheduling
SUL Supplemental Uplink
TB Transport Block
TBS Transport Block Size
TDoA Time Difference of Arrival
ToF Time of Flight
TRP Transmission-Reception Point (used interchangeably with GnB)
TSC Time-sensitive communications
TSN Time-sensitive networking
TTI Transmission Time Interval
UCI Uplink Control Information
UL Uplink
URLLC Ultra-Reliable and Low Latency Communications
WBWP Wide Bandwidth Part
WTRU Wireless Transmit Receive Unit
WLAN Wireless Local Area Networks and related technologies (IEEE 802.xx domain)

Sidelink synchronization signals (S-SS/PSBCH blocks or S-SSBs) and related Master Information Block (MIB) are key for WTRUs to perform synchronization procedures on a sidelink connection. In embodiments, corrupted S-SS/PSBCH blocks due to overlapping high-power narrowband interferers (e.g., in some spectrum sharing scenarios or due to an intentional jammer) in time and frequency domains should be avoided or mitigated in wireless sidelink communications.

In embodiments, a single sidelink bandwidth part (SL BWP) per cell is allowed. Each cell may be associated to only one set of S-SS/PSBCH blocks. In general, the bandwidth of the S-SS/PSBCH blocks (11 RBs) are narrower compared to the overall SL BWP bandwidth. When a narrow-band high power interferer lends itself onto the frequency locations where S-SS/PSBCH blocks transmit, the neighboring WTRUs may not be able to detect the synchronization signals for sidelink communications due to high level of interference. Embodiments for S-SS/PSBCH blocks transmission to cope with high-power narrowband interference overlapping in time and frequency domains affecting S-SS/PSBCH reception are described herein. In embodiments, frequency hopped S-SSB transmission is described to mitigate high-power narrowband interference such that if one frequency location of S-SSBs is corrupted by a high-power narrowband interference, another frequency location of the S-SSBs may not be affected.

Time-frequency structure of an S-SS/PSBCH block is described below.

To enable devices to indirectly synchronize with the master sync reference via another device, devices may be configured to transmit a sidelink S-SS/PSBCH block (S-SSB). The basic structure of the S-SS/PSBCH block consists of a sidelink primary synchronization signal (S-PSS), a sidelink secondary synchronization signal (S-SSS), and a physical sidelink broadcast channel (PSBCH), which carries a very limited amount of information (the sidelink MIB) relevant for the synchronization. The sidelink MIB (MasterInformationBlockSidelink) includes the system information transmitted by a WTRU via SL-BCH.

The main purpose of the PSBCH is to provide system-wide information and synchronization information that is required by a WTRU for establishing a sidelink connection. The information carried by the PSBCH includes a one-bit indicator regarding whether the SyncRef WTRU is in coverage of a network or of GNSS. A WTRU is in coverage of GNSS when GNSS is reliable at the WTRU.

Sidelink transmissions are organized in frames identified by the direct frame number (DFN). Consequently, the PSBCH also indicates the DFN and the slot index as timing information. The DFN enables a WTRU to synchronize its radio frame transmissions according to the SL timing reference. For a SyncRef WTRU in network coverage, the DFN may be derived based on the system frame number (SFN), where the SFN provides an indexing of the frames based on the cell timing reference. When a WTRU is out of network coverage, the DFN may be derived based on the coordinated universal time (UTC) provided by GNSS (i.e., GNSS timing).

For paired spectrum (i.e., FDD), an S-SS/PSBCH block may be transmitted/received only in a slot of an UL carrier. For unpaired spectrum (i.e., TDD), an S-SS/PSBCH block may be transmitted/received only in a slot of which all OFDM symbols are semi-statically configured as UL as per the higher layer parameter tdd-UL-DL-ConfigurationCommon of the serving cell if provided or sl-TDD-Configuration-r16 if provided or sl-TDD-Config-r16 of the received PSBCH if provided. Or if tdd-UL-DL-ConfigurationCommon and sl-TDD-Configuration are not provided an S-SS/PSBCH block may be transmitted/received in any slot of the spectrum. For transmission of an S-SS/PSBCH block, a WTRU includes a bit sequence a0, a1, a2, a3, . . . , a11 in the PSBCH payload to indicate sl-TDD-Config and provide a slot format over a number of slots.

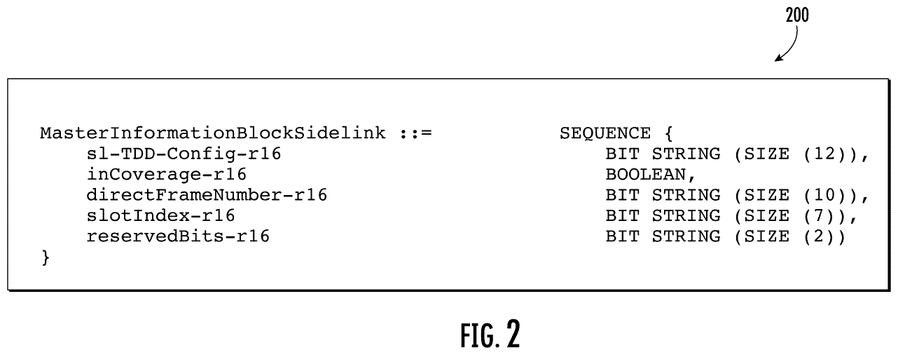

An example configuration 200 is shown in FIG. 2, wherein: directFrameNumber indicates the frame number in which S-SSB is transmitted; inCoverage: value true indicates that the WTRU transmitting the MasterInformationBlockSidelink is in network coverage, or the WTRU selects GNSS timing as the synchronization reference source; and slotindex indicates the slot index in which the S-SSB is transmitted.

In the time domain, an S-SS/PSBCH block may consist of

$${N}_{symb}^{S - SSB}$$

OFDM symbols, numbered in increasing order from 0 to

$${N}_{symb}^{S - SSB} - 1$$

within the S-SS/PSBCH block, where S-PSS, S-SSS, and PSBCH with associated DM-RS are mapped to symbols as given by Error! Reference source not found. The number of OFDM symbols in an S-SS/PSBCH block

$${N}_{symb}^{S - SSB} = 13$$

for normal cyclic prefix and

$${N}_{symb}^{S - SSB} = 11$$

for extended cyclic prefix. The first OFDM symbol in an S-SS/PSBCH block is the first OFDM symbol in the slot.

In the frequency domain, an S-SS/PSBCH block (or S-SSB) may consist of 132 contiguous subcarriers (11 RBs) with the subcarriers numbered in increasing order from 0 to 131 within the S-SS/PSBCH block. The quantities k and l represent the frequency and time indices, respectively, within one S-SS/PSBCH block. The S-SSB is not frequency multiplexed with any other sidelink physical channel within the SL BWP, i.e., S-SSBs are not transmitted in the slots of a resource pool. The frequency location of an S-SSB is (pre-) configured within a SL BWP. As a result, a WTRU does not need to perform blind detection in the frequency domain to find an S-SSB.

Table 1 describes example resources within an S-SS/PSBCH block for S-PSS, S-SSS, PSBCH and DM-RS.

TABLE 1

| | OFDM symbol number l | Subcarrier number k |
|---|---|---|
| Channel or | relative to the start of an | relative to the start of an |
| signal | S-SS/PSBCH block | S-SS/PSBCH block |
| S-PSS | 1, 2 | 2, 3, . . . , 127, 128 |
| S-SSS | 3, 4 | 2, 3, . . . , 127, 128 |
| Set to zero | 1, 2, 3, 4 | 0, 1, 129, 130, 131 |
| PSBCH | 0, 5, 6, . . . , N_{symb}^{S-SSB} − 1 | 0, 1, . . . , 131 |
| DM-RS for | 0, 5, 6, . . . , N_{symb}^{S-SSB} − 1 | 0, 4, 8, . . . , 128 |
| PSBCH | | |

The S-PSS and S-SSS are jointly referred to as the sidelink synchronization signal (SLSS). The SLSS is used for time and frequency synchronization. By detecting the SLSS sent by a SyncRef WTRU, a WTRU is able to synchronize to the SyncRef WTRU and estimate the beginning of the frame and carrier frequency offsets. The WTRU may use the SL timing reference provided by the SyncRef WTRU for SL transmissions with nearby WTRUs that are using the same timing reference. Thus, not every WTRU needs to transmit S-SSBs and be a SyncRef WTRU.

For an S-SS/PSBCH block, the WTRU may use antenna port 4000 for transmission of S-PSS, S-SSS, PSBCH and DM-RS for PSBCH; and the same cyclic prefix length and subcarrier spacing for the S-PSS, S-SSS, PSBCH and DM-RS for PSBCH.

A WTRU may be provided by SL-BWP-ConfigCommon and SL-BWP-Config with a bandwidth part (i.e., SL BWP) for SL transmissions.

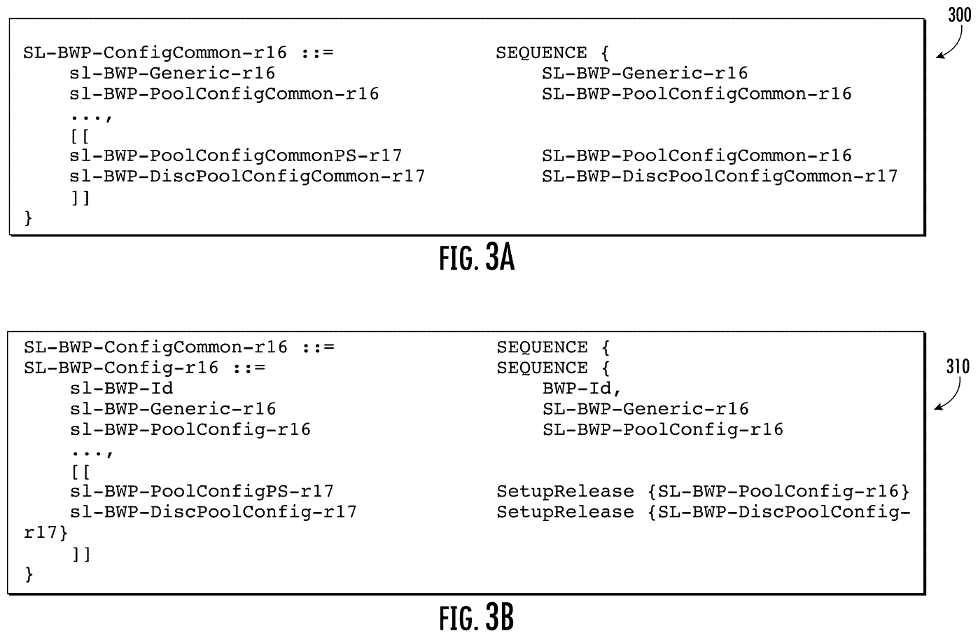

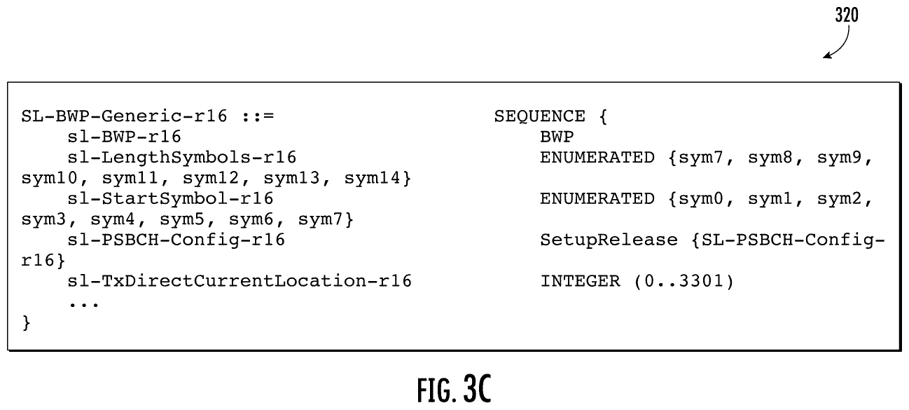

FIG. 3A, 300 shows an exemplary configuration for SL-BWP-Generic-r16. FIG. 3B, 310 shows an exemplary configuration for SL-BWP-Config-r16. FIG. 3C, 320 shows an exemplary configuration for SL-BWP-Generic-r16.

For the reception of an S-SS/PSBCH block, a WTRU may assume a frequency location (corresponding to the subcarrier with index 66 in the S-SS/PSBCH block) is provided by sl-AbsoluteFrequencySSB in the SL-FreqConfigCommon-r16 IE (which in turn is provided in the sl-ConfigCommonNR-r16 IE in SIB12 or in the SidelinkPreconfigNR-r16 IE in SL-PreconfigurationNR-r16) and provided by the SL-FreqConfig-r16 IE (which in turn is provided in the SL-PHY-MAC-RLC-Config-r16 IE in SL-ConfigDedicatedNR-r16 within RRCReconfiguration-v1610). The WTRU assumes that an S-PSS symbol, an S-SSS symbol, and a PSBCH symbol have the same transmission power; the WTRU assumes the same numerology of the S-SS/PSBCH as for a SL BWP of the S-SS/PSBCH block reception, and that the bandwidth of the S-SS/PSBCH is within a bandwidth of the SL BWP; the WTRU assumes the subcarrier with index 0 in the S-SS/PSBCH block is aligned with a subcarrier with index 0 in an RB of the SL BWP.

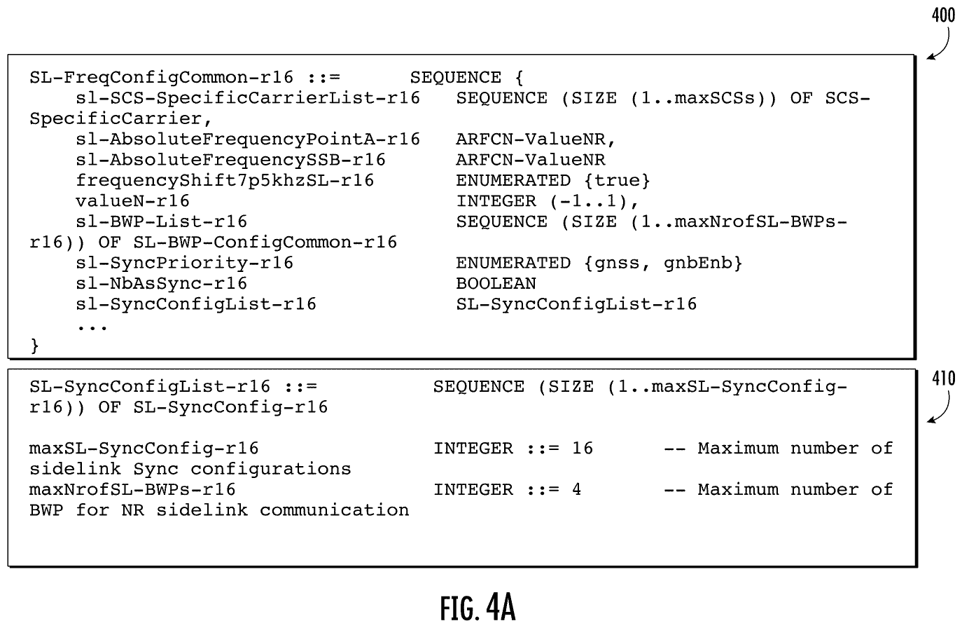

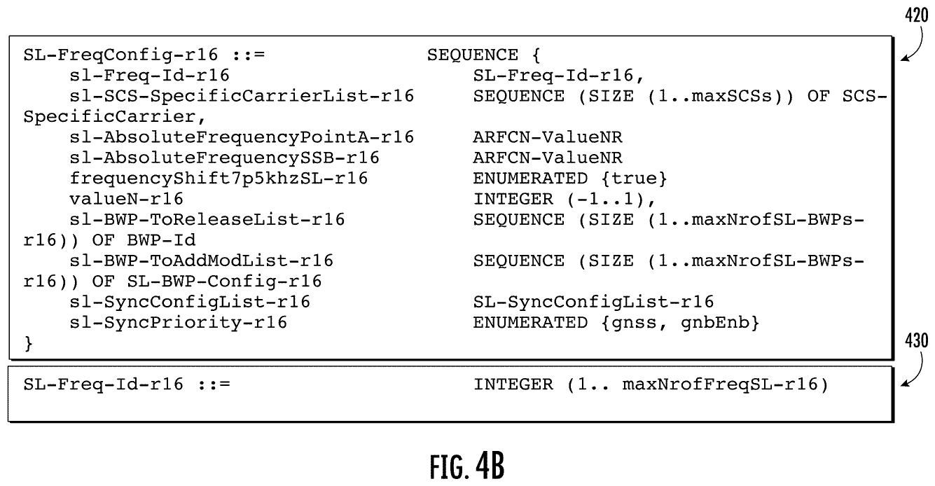

FIG. 4A, 400 shows an exemplary configuration for SL-FreqConfigCommon-r16. FIG. 4A, 410 shows an exemplary configuration for SL-SyncConfigList-r16. FIG. 4B, 420 shows an exemplary configuration for SL-FreqConfig-r16 and FIG. 4B, 430 shows an exemplary configuration for SL-Freq-Id-r16.

With respect to FIGS. 4A and 4B, the following apply:
sl-AbsoluteFrequencyPointA is the absolute frequency of the reference resource block (Common RB 0). Its lowest subcarrier is also known as Point A.
sl-AbsoluteFrequencySSBIndicates the frequency location of sidelink SSB. The transmission bandwidth for sidelink SSB is within the bandwidth of this sidelink BWP.
sl-BWP-List indicates the list of sidelink BWP(s) on which the NR sidelink communication configuration. In R16, only one BWP is allowed to be configured for NR sidelink communication.
sl-SyncPriority indicates synchronization priority order.
sl-SyncConfigList indicates the configuration by which the WTRU is allowed to receive and transmit synchronisation information for NR sidelink communication. Network configures sl-SyncConfig including txParameters when configuring UEs to transmit synchronization information. If this field is configured in SL-PreconfigurationNR-r16, only one entry is configured in sl-SyncConfigList.

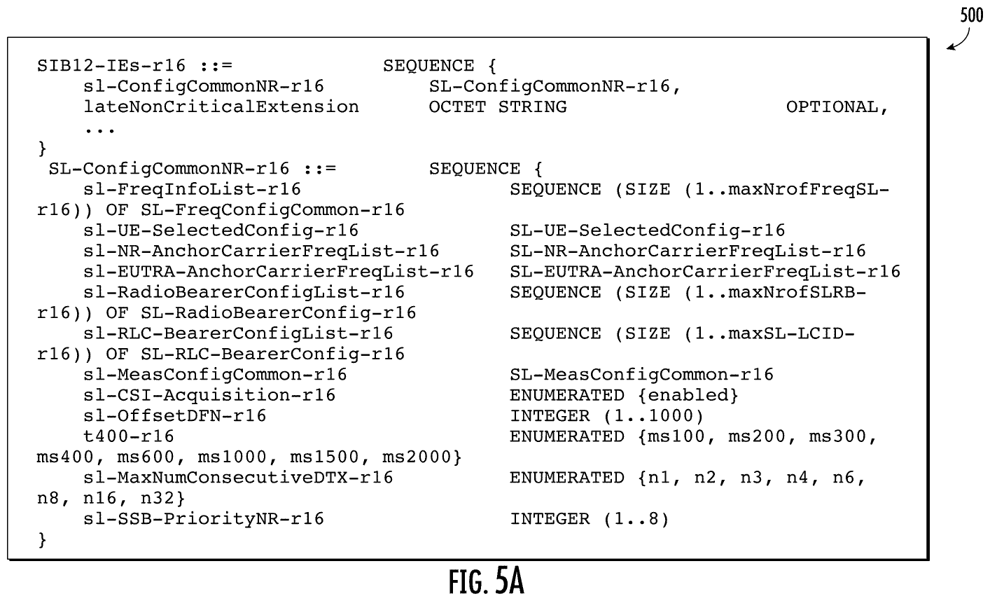

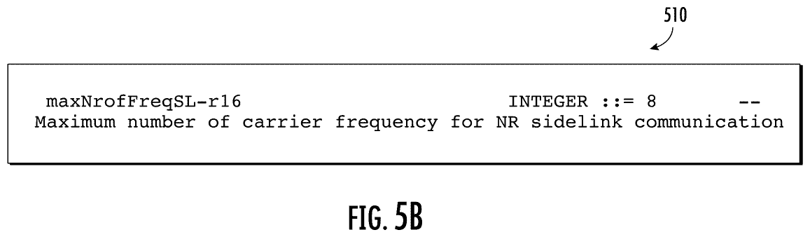

FIG. 5A, 500 shows an exemplary configuration for SIB12-IEs-r16. FIG. 5B, 510 shows an exemplary configuration for maxNrofFreqSL-r16. With respect to FIG. 5A, the following apply:
sl-FreqInfoList indicates the NR sidelink communication configuration on one or more carrier frequencies. In this release, only one entry may be configured in the list. sl-SSB-PriorityNR indicates the priority of NR sidelink SSB transmission and reception.

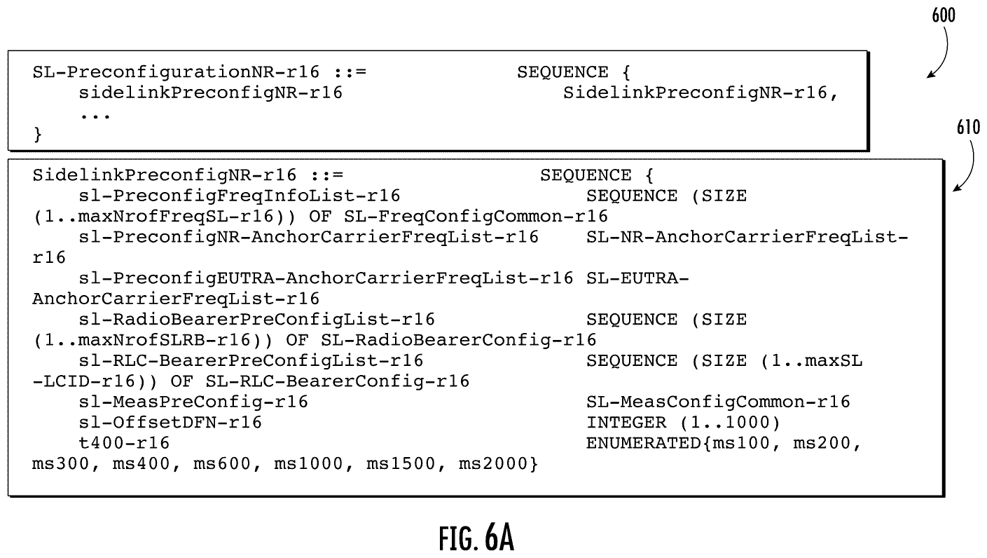

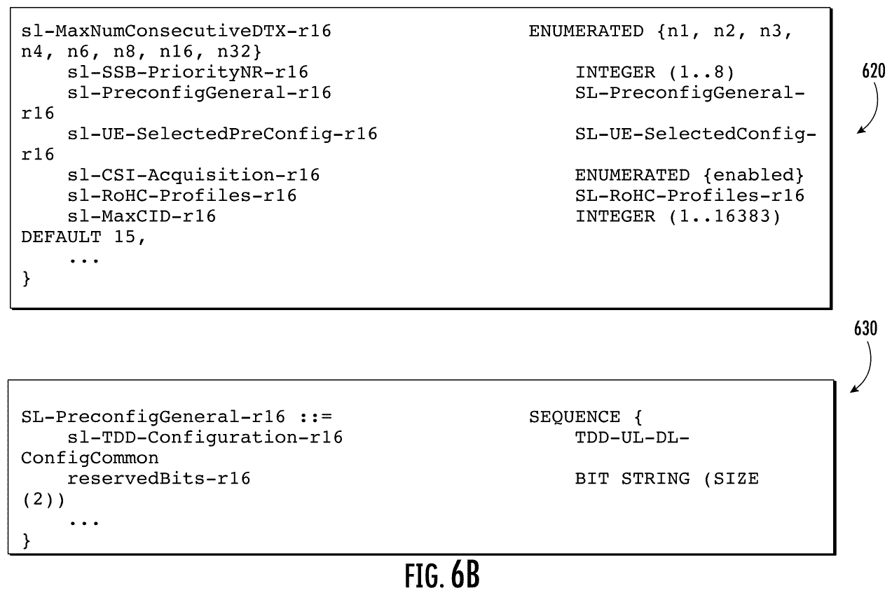

FIG. 6A, 600 shows an exemplary configuration for SL-PreconfigurationNR-r16. FIG. 6A, 610 shows an exemplary configuration for SidelinkPreconfigNR-r16. FIG. 6B, 620 shows an exemplary configuration for sl-MaxNumConsecutiveDTX-r16. FIG. 6B, 630 shows an exemplary configuration for SL_PreconfigGeneral-r16. With respect to FIGS. 6A and 6B, the following apply:
sl-PreconfigFreqInfoList indicates the NR sidelink communication configuration some carrier frequency (ies). In this release, only one SL-FreqConfigCommon may be configured in the list.
sl-SSB-PriorityNR indicates the priority of NR sidelink SSB transmission and reception.

In embodiments, locations are predetermined in the time domain where a WTRU may monitor for a possible S-SS/PSBCH. A WTRU may be provided (in the SL-SSB-TimeAllocation-r16 IE within the SL-SyncConfig-r16 IE), by sl-NumSSB-WithinPeriod, a number

$${N}_{period}^{S - SSB}$$

of S-SSIPSBUH DIOCKS In a period of 16 frames. The WTRU may assume that a transmission of the S-SS/PSBCH blocks in the period is with a periodicity of 16 frames. The WTRU may determine indexes of slots that include S-SS/PSBCH block as

$${N}_{offset}^{S - SSB} + ( {N}_{interval}^{S - SSB} + 1 ) \cdot {i}_{S - SSB} ,$$

where
index 0 corresponds to a first slot in a frame with SFN satisfying (SFN mod 16)=0
i_{S-SSB} is a S-SS/PSBCH block index within the number of S-SS/PSBCH blocks in the period, with

$$0 \leq {i}_{S - SSB} \leq {N}_{period}^{S - SSB} - 1$$

$${N}_{offset}^{S - SSB}$$

is a sivt UnISEL IIUIT a stan or uc period to the first slot including S-SS/PSBCH block, provided by sl-TimeOffsetSSB

$${N}_{interval}^{S - SSB}$$

is a sivt Interval between 3-borPSBCH blocks, provided by sl-timeInterval

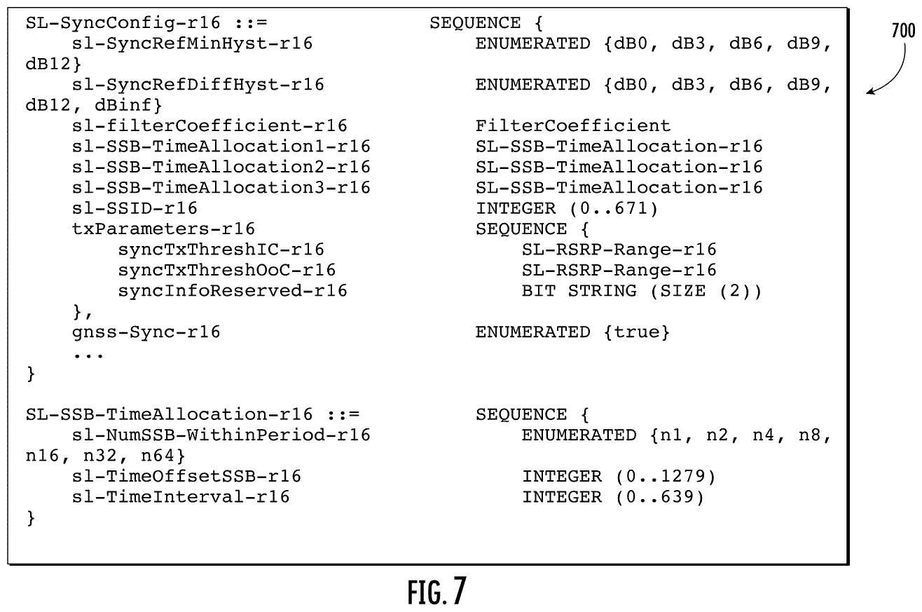

FIG. 7, 700 shows an exemplary configuration for SL-SyncConfig-r16. FIG. 7, 710 shows an exemplary configuration for SL-SSB-TimeAllocation-r16.

Exemplary NR sidelink synchronization procedures are described herein.

Before devices may be involved in sidelink communication, they need to be reasonably well synchronized to each other and to the overlaid cellular network if present. The aim of sidelink synchronization is to ensure synchronization, more specifically, to ensure that all sidelink devices operate with a common clock that may eventually be tracked back to a master sync reference. The reference may be the timing of a cellular network or may be provided by a global navigation satellite system (GNSS), such as GPS.

Assuming the master sync reference is provided by the cellular network, devices directly under coverage of a cell of the overlaid network should acquire its synchronization directly from the master sync reference. To enable synchronization also for devices outside of the direct coverage of the network, a device may indirectly synchronize to the master sync reference (in this case, the network) via another device. That other device could, in itself, either be directly or indirectly synchronized to the master sync reference. In this way, a synchronization chain consisting of a sequence of devices may be established.

A WTRU may receive the following sidelink (SL) synchronization signals in order to perform synchronization procedures based on S-SS/PSBCH blocks: SL primary synchronization signals (S-PSS) and SL secondary synchronization signals (S-SSS). A WTRU may assume that reception occasions of a physical sidelink broadcast channel (PSBCH), S-PSS, and S-SSS are in consecutive symbols and form a S-SS/PSBCH block (TS 38.211).

There are two different S-PSS and 336 different S-SSS to choose from. This jointly provides 672 different S-PSS/S-SSS combinations corresponding to 672 different sidelink identities (SLSS IDs). To support prioritization in the sidelink synchronization, there are two groups of sidelink identities:

The first group of sidelink identities (in-coverage sidelink identities) may be used for S-SS/PSBCH transmission by either in-coverage devices, that is devices that have directly acquired their synchronization from the master sync reference, or devices that has acquired their synchronization directly from such in-coverage devices. In-coverage SLSS IDs={0, 1, . . . , 335}

The second group of sidelink identities (out-of-coverage sidelink identities) may be used for S-SS/PSBCH transmission by all other devices. Out-of-coverage SLSS IDs={336, 337, . . . , 671}

In embodiments there may be a way for a device that acquires an S-SS/PSBCH based on in-coverage sidelink identity to determine if the S-SS/PSBCH is transmitted from an in-coverage device, that is device under the direct coverage of the master sync reference or not. To enable this, the sidelink MIB includes an in-coverage indicator (inCoverage-r16), which is set to true only for in-coverage devices.

In embodiments, a device may always acquire synchronization to a source that is as close as possible to the master sync reference. Thus, when searching for sources for synchronization (i.e., searching for S-SS/PSBCH blocks), a device should: prioritize in-coverage sidelink identities over out-of-coverage sidelink identities; and, in case of an in-coverage sidelink identity, prioritize in-coverage devices, that is, devices for which in-coverage indicator is set to true.

These rules will create a synchronization chain originating at the master sync reference (nominally the cellular network), via an in-coverage device and providing indirect synchronization to out-of coverage devices either directly via the in-coverage devices or indirectly via one or several out-of-coverage devices.

The selection of a SyncRef WTRU is based on the SLSS ID and the in-coverage indicator. Depending on the priority level, a WTRU first searches for SyncRef WTRUs with certain SLSS IDs, i.e., SyncRef WTRUs transmitting a certain combination of S-PSS and S-SSS. For each SLSS ID, the WTRU measures an RSRP based on PSBCH DMRS sent by a SyncRef WTRU. Depending on WTRU implementation, the S-SSS may also be used for computing the RSRP. For SLSS IDs with RSRP above a preconfigured threshold, the WTRU may check the value of the in-coverage indicator carried in the PSBCH. In this way, a WTRU may determine the SyncRef WTRUs which are its candidate synchronization reference for a given priority level. For multiple candidate SyncRef WTRUs in the same priority level, the SyncRef WTRU with the highest RSRP may have the higher priority. Independently of the set of priorities utilized, a WTRU that is unable to find any other synchronization reference (i.e., GNSS, a gNB/eNB or a SyncRef WTRU) my use its own internal clock as synchronization reference.

The situation of a WTRU may change regarding available synchronization references, e.g., a higher priority synchronization reference becomes available. Thus, a WTRU may frequently searches for synchronization references with the objective to select the highest priority synchronization reference that is available. To this end, the WTRU may perform a full search, covering all subframes and all possible SLSSIDs, to detect candidate SLSS.

In embodiments of sidelink, there are two general procedures for triggering S-SSB transmissions at a WTRU (i.e., for the WTRU becoming a SyncRef WTRU): (i) a WTRU may be configured by the network to become a SyncRef WTRU; or (ii) a WTRU may decide on its own whether to become a SyncRef WTRU when in or out of network coverage. A SyncRef WTRU sends S-SSBs based on the timing reference provided by its synchronization reference.

A WTRU that is in coverage of a gNB may be configured by the network to transmit or not to transmit S-SSBs. In the former case, the WTRU is network configured to become a SyncRef WTRU, while in the latter case the WTRU is network configured not to act as a SyncRef WTRU. A network configured SyncRef WTRU sends S-SSBs irrespective of whether it has any data to transmit in the sidelink. The SyncRef WTRU knows which SLSS ID and resources to use for the S-SSB transmissions based on the sidelink system information provided by the network to WTRUs in the cell.

The network configuration of a WTRU to send or not to send S-SSBs is optional. Consequently, a WTRU in network coverage may not be configured to transmit or not to transmit S-SSBs. If a WTRU in network coverage has not received such configuration and the WTRU has data to transmit in the sidelink, the WTRU may decide on its own whether to transmit S-SSBs or not. This is in contrast to the network configured scenario where the decision regarding S-SSB transmissions is taken by the network, e.g., regardless whether the WTRU has data to transmit in the sidelink.

A WTRU may decide on its own to become a SyncRef WTRU by comparing its RSRP of the serving gNB with a threshold provided by the network. The WTRU measures the RSRP based on reference signals (e.g., PBCH DMRS) associated with the synchronization signal sent by the serving gNB. If the RSRP is below the provided threshold, the WTRU may become a SyncRef WTRU and transmit S-SSBs. The SyncRef WTRU knows which SLSS ID and resources to use for the S-SSB transmissions based on the sidelink system information provided by the network in the cell. If the RSRP of the serving gNB is above or equal to the threshold, the WTRU does not send S-SSBs. This RSRP-based triggering of S-SSB transmissions results in having WTRUs close to the cell edge becoming SyncRef WTRUs, if they have data to transmit in the sidelink. Triggering S-SSB transmissions by a WTRU close to cell edge allows expanding the synchronization coverage of the serving gNB. This allows WTRUs with very poor network coverage or out of network coverage to use the timing reference of the serving gNB, i.e., for SL communication with WTRUs inside the cell. In embodiments, it may not be desirable for WTRU's which are in good network coverage (i.e., close to the gNB and with the RSRP≥threshold) to transmit S-SSBs. The area that these WTRUs could cover with their S-SSB transmissions is already within the coverage of the serving gNB.

If a WTRU is synchronized to a SyncRef WTRU and has data to transmit in the sidelink, it may decide on its own whether to transmit S-SSBs or not. A WTRU synchronized to a selected SyncRef WTRU may itself become a new SyncRef WTRU if the RSRP of its selected SyncRef WTRU is below a preconfigured threshold. The RSRP is measured based on PSBCH DMRS sent in S-SSB transmissions of the selected SyncRef WTRU. The resources on which the new SyncRef WTRU sends S-SSBs may be preconfigured, with the new SyncRef WTRU transmitting S-SSBs on different resources than the ones used by the selected SyncRef WTRU. If the selected SyncRef WTRU has an SLSS ID from the set of out-of-coverage SLSS IDs, the new SyncRef WTRU may transmit S-SSBs with this same SLSS ID. If the selected SyncRef WTRU has an SLSS ID from the set of in-coverage SLSS IDs, the new SyncRef WTRU may transmit the S-SSBs with an SLSS ID equal to the SLSS ID of the selected SyncRef WTRU plus 336. If the WTRU measures an RSRP of its selected SyncRef WTRU which is above or equal to the (pre-) configured threshold, the WTRU does not send S-SSBs. This RSRP-based triggering of S-SSB transmissions results in having WTRUs near the edge of the synchronization coverage becoming SyncRef WTRUs if they have data to transmit in the sidelink. This enables expanding the synchronization coverage which aids nearby WTRUs in out-of-network coverage to share the same timing reference for SL communication.

If a WTRU has data to transmit in the sidelink and uses its internal clock as synchronization reference, the WTRU may become a SyncRef WTRU. The SyncRef WTRU transmits S-SSBs with an SLSS ID randomly chosen from the set of out of coverage SLSS IDs excluding 336 and 337. The resources used to send S-SSBs are preconfigured.

Embodiments for frequency hopped S-SSB transmission to mitigate high-power narrowband interference are described below.

In embodiments, frequency hopped S-SS/PSBCH blocks (S-SSBs) transmission within the SL BWP may be used to mitigate high power narrowband interferer by alternating the S-SSBs in the frequency domain (e.g., near the two edge of the SL BWP) such that if one frequency location of the S-SSBs is corrupted by the high-power narrowband interferer, another frequency location of the S-SSBs may not be affected.

In embodiments, to facilitate frequency hopping, a new field sl-Absolute2ndHopFrequencySSB may be added to the SL-FreqConfigCommon-r16 IE (e.g., in SL-ConfigCommonNR-r16 IE of SIB12 or in the SidelinkPreconfigNR-r16 IE of SL-PreconfigurationNR-r16) to provide the second hop synchronization raster location(s) of the S-SSB. Similarly, sl-Absolute2ndHopFrequencySSB may also be introduced in the SL-FreqConfig-r16 IE (e.g., in sl-PHY-MAC-RLC-Config-r16 IE of SL-ConfigDedicatedNR-r16) to provide the second hop synchronization raster location(s) of the S-SS/PSBCH blocks during RRC reconfiguration. The sl-Absolute2ndHopFrequencySSB may also be (pre) configured, thus a WTRU attempting to perform sidelink communication may monitor both frequency locations of sl-AbsoluteFrequencySSB-r16 and sl-Absolute2ndHopFrequencySSB for a possible S-SS/PSBCH blocks to obtain sidelink synchronization.

Frequency hopping may be performed within a (e.g., 160 ms)S-SSB transmission period (intraSSBPeriod) or between different S-SSB transmission periods (interSSBPeriod), to be configured by a new parameter sl-FrequencyHoppingTypeSSB.

In embodiments, in a case where sl-FrequencyHoppingTypeSSB is set to ‘intraSSBPeriod’, frequency hopping may be performed in the following manner: The frequency location specified by sl-AbsoluteFrequencySSB-r16 corresponds to the S-SSB transmission with even value of S-SSB index (i_(S-SSB)). The frequency location specified by sl-Absolute2ndHopFrequencySSB corresponds to the S-SSB transmission with odd value of S-SSB index (i_(S-SSB)).

In embodiments, in a case where sl-FrequencyHoppingTypeSSB is set to ‘interSSBPeriod’, frequency hopping may be performed in the following manner: The frequency location specified by sl-AbsoluteFrequencySSB-r16 corresponds to the S-SSB transmission period with DFN satisfying floor (DFN/16)=even. The frequency location specified by si-Absolute2ndHopFrequencySSB corresponds to the S-SSB transmission period with DFN satisfying floor (DFN/16)=odd.

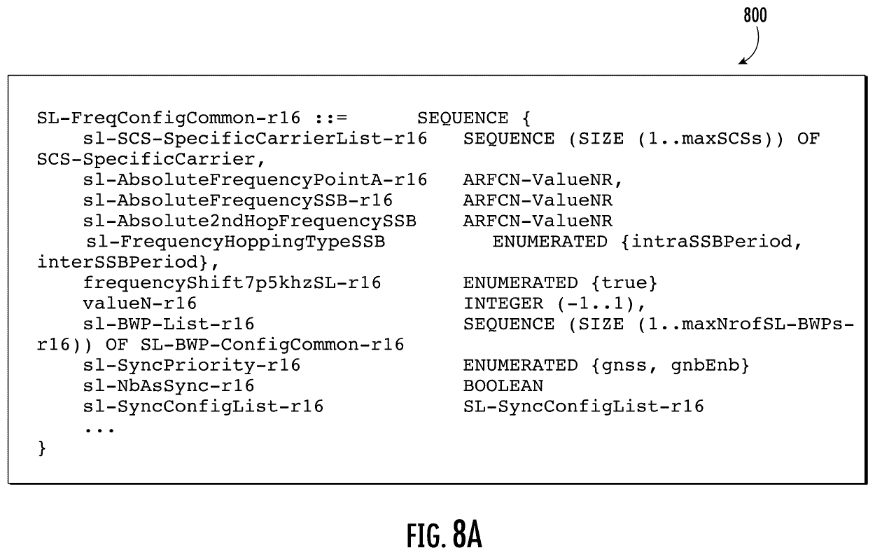

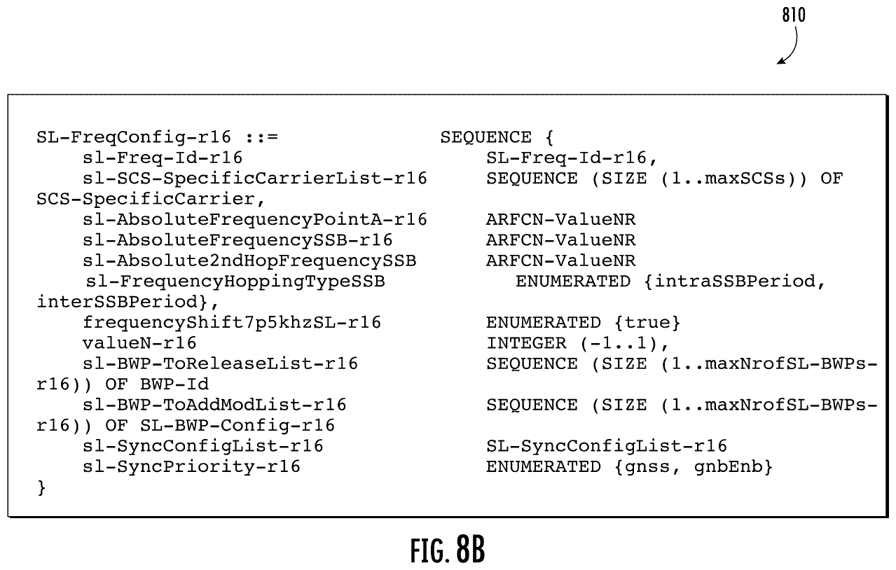

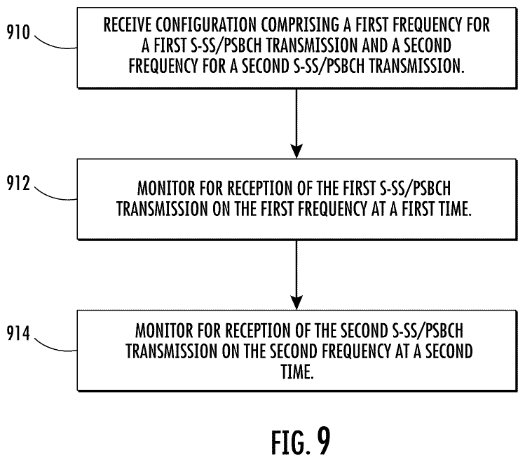

FIG. 8A, 800 shows an exemplary configuration for SL-FreqConfigCommon-r16. FIG. 8B, 810 shows an exemplary configuration for SL-FreqConfig-r16.

In further embodiments, the order of the hopping frequency location (e.g., whether the first hop frequency location is associated with the even S-SSB index or the odd S-SSB index in the case of ‘intraSSBPeriod’ frequency hopping, and similarly the hopping frequency location in relation to DFN for the case of ‘interSSBPeriod’) may be defined by a separate (pre) configured parameter. In addition, the ‘intraSSBPeriod’ and/or ‘interSSBPeriod’ S-SSB frequency hopping periodicities may be defined using (pre) configured parameters.

In embodiments, the hopping rules described above may be applied only for WTRUs that derive their synchronization directly from a master sync reference (e.g., gNB or GNSS). In this embodiment, other WTRUs may transmit S-SSBs in the opposite hopping order relative to its SyncRef WTRU to minimize the sidelink synchronization signal mutual interference among WTRUs.

When S-SSB beam sweeping is used (e.g., in FR2), the frequency hopping pattern may be exemplified as follows, in a case where sl-FrequencyHoppingTypeSSB is set to ‘intraSSBPeriod’, frequency hopping with beam sweeping may be performed in the following manner: For a given beam direction, the S-SSB may hop over different frequency locations before transmitting in the next beam direction. A full sweep of all beam directions may be completed within a single S-SSB transmission period.

In further embodiments, the S-SSB beams may be transmitted from one frequency location for a set of the beams in a complete sweep (e.g., S-SSB beams with even S-SSB index). A second set of S-SSB beams within the same sweep are then transmitted from another frequency location (e.g., S-SSB beams with odd S-SSB index). A full sweep of all beam directions is completed within a single S-SSB transmission period.

In further embodiments, the S-SSB beams may be first transmitted from one frequency location for a complete sweep. The same set of S-SSB beams may then be transmitted from another frequency location for the second sweep and transmissions over all configured frequency locations over two (or more) sweeps may be completed in a single S-SSB transmission period.

When S-SSB beam sweeping is used (e.g., in FR2), the frequency hopping pattern may be exemplified as follows, in a case where sl-FrequencyHoppingTypeSSB is set to ‘interSSBPeriod’, frequency hopping with beam sweeping may be performed in the following manner: The S-SSB beams may be first transmitted from one frequency location for one or more complete sweeps within a S-SSB transmission period. The same set of S-SSB beams may be then transmitted from another frequency location for the second round of sweeps in the next S-SSB transmission period and continue to alternate between (among) the two (or more) frequency locations for different S-SSB transmission periods.

In embodiments, a WTRU may inform its peer sidelink WTRUs (as part of UECapabilityInformation Sidelink in PC5 RRC) and/or the network (as part of UECapabilityInformation in Uu RRC) of its capability to support frequency hopping of S-SS/PSBCH blocks, as exemplified by the following information message shown in TABLE 2.

TABLE 2

| | | | FDD − TDD | FR1 − FR2 |
|---|---|---|---|---|
| Definitions for parameters | Per | M | DIFF | DIFF |
| sl-SSBFrequencyHopping | WTRU | No | No | No |
| Indicates whether the WTRU | | | | |
| supports frequency hopping | | | | |
| of S-SS/PSBCH blocks. | | | | |

In embodiments, two (or more)S-SSB frequency locations may be allocated that are far apart in the SL BWP to facilitate frequency hopping. Therefore, if one of the S-SSB frequency locations is corrupted by the high-power narrowband interferer, the other S-SSB frequency location(s) that is or are not affected may be used to sustain the sidelink synchronization operation.

In a case where frequency hopped S-SSB is not (pre) configured, a WTRU attempting to perform sidelink communication may monitor the (pre) configured S-SSB frequency location to obtain sidelink synchronization.

In a case where frequency hopped S-SSB is (pre) configured, a WTRU attempting to perform sidelink communication may monitor the (pre) configured S-SSB frequency hopped locations to obtain sidelink synchronization.

In embodiments, frequency hopping may be performed within a S-SSB transmission period (intraSSBPeriod) or between different S-SSB transmission periods (interSSBPeriod).

Embodiments may include ‘intraSSBPeriod’ S-SSB frequency hopping, wherein the first frequency location corresponds to the S-SSB transmission with even value of S-SSB index. The second frequency location corresponds to the S-SSB transmission with odd value of S-SSB index.

Embodiments may include ‘interSSBPeriod’ S-SSB frequency hopping, wherein the first frequency location corresponds to the S-SSB transmission period with DFN satisfying floor (DFN/16)=even. The second frequency location corresponds to the S-SSB transmission period with DFN satisfying floor (DFN/16)=odd.

In the case of S-SSB beam sweeping (e.g., in FR2), an example of ‘intraSSBPeriod’ S-SSB frequency hopping involves that for a given beam direction, the S-SSB hops over different frequency locations before transmitting in the next beam direction. A full sweep of all beam directions is completed within a single S-SSB transmission period.

In further embodiments, S-SSB beams may be transmitted from one frequency location for a set of the beams in a complete sweep (e.g., S-SSB beams with even S-SSB index). A second set of S-SSB beams within the same sweep may then be transmitted from another frequency location (e.g., S-SSB beams with odd S-SSB index). A full sweep of all beam directions may be completed within a single S-SSB transmission period.

In further embodiments, the S-SSB beams may be first transmitted from one frequency location for a complete sweep. The same set of S-SSB beams are then transmitted from another frequency location for the second sweep and transmissions over all configured frequency locations over two (or more) sweeps may be completed in a single S-SSB transmission period.

In a further embodiment of S-SSB beam sweeping (e.g., in FR2), an example of ‘interSSBPeriod’ S-SSB frequency hopping involves the S-SSB beams being first transmitted from one frequency location for one or more complete sweeps within a S-SSB transmission period. The same set of S-SSB beams may then transmitted from another frequency location for the second round of sweeps in the next S-SSB transmission period and continue to alternate between (among) the two (or more) frequency locations for different S-SSB transmission periods.

In embodiments, the order of the hopping frequency location (e.g., whether the first hop frequency location is associated with the even S-SSB index or the odd S-SSB index in the case of ‘intraSSBPeriod’ frequency hopping, and similarly the hopping frequency location in relation to DFN for the case of ‘interSSBPeriod’ frequency hopping) may be defined by a (pre) configured parameter.

The ‘intraSSBPeriod’ and/or ‘interSSBPeriod’ S-SSB frequency hopping periodicities may be defined via (pre) configured parameters.

In further embodiments, the hopping rules described above may be applied only to WTRUs that derive their synchronization directly from a master sync reference (e.g., gNB or GNSS). Other WTRUs may transmit S-SSBs in the opposite hopping order relative to its SyncRef WTRU to minimize the sidelink synchronization signal mutual interference among WTRUs.

In embodiments, a WTRU may inform the peer sidelink WTRUs and/or the network of its capability to support frequency hopping of S-SSBs.

FIG. 9 is a flow chart for an exemplary embodiment for reception of S-SSB/PSBCH by a WTRU. At 910 a WTRU may receive a configuration comprising a first frequency for a first S-SS/PSBCH transmission and a second frequency for a second S-SS/PSBCH transmission. At 912, the WTRU may monitor for reception of the first S-SS/PSBCH transmission on the first frequency at a first time. At 914, the WTRU may monitor for reception of the second S-SS/PSBCH transmission on the second frequency at a second time.

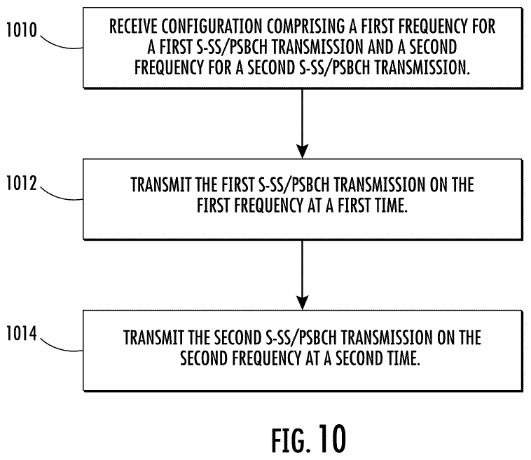

FIG. 10 is a flow chart for an exemplary embodiment for transmission of S-SS/PSBCH by a WTRU. At 1010, a WTRU may receive a configuration comprising a first frequency for a first S-SS/PSBCH transmission and a second frequency for a second S-SS/PSBCH transmission. At 1012 the WTRU may transmit the first S-SS/PSBCH transmission on the first frequency at a first time. At 1014, the WTRU may transmit the second S-SS/PSBCH transmission on the second frequency at a second time.

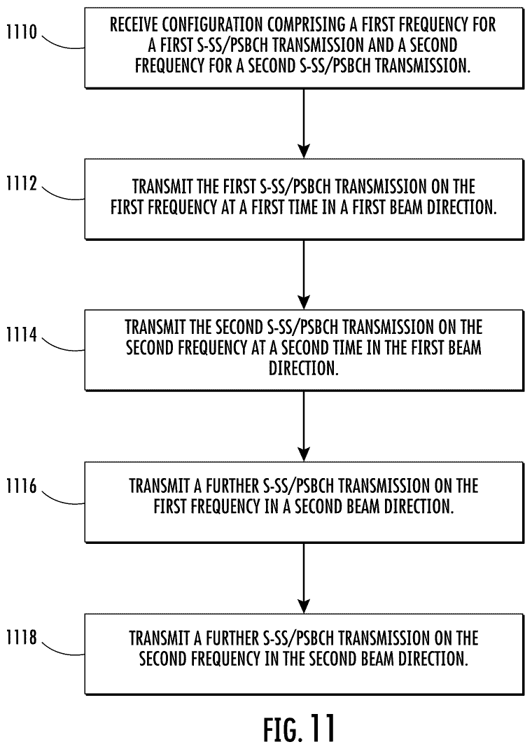

FIG. 11 is a flow chart for an exemplary embodiment for transmission of S-SS/PSBCH by a WTRU. At 1110, a WTRU may receive a configuration comprising a first frequency for a first S-SS/PSBCH transmission and a second frequency for a second S-SS/PSBCH transmission. At 1112, the WTRU may transmit the first S-SS/PSBCH transmission on the first frequency at a first time in a first beam direction. At 1114, the WTRU may transmit the second S-SS/PSBCH transmission on the second frequency at a second time in the first beam direction. At 1116, the WTRU may transmit a further S-SS/PSBCH transmission on the first frequency in a second beam direction. At 1118, the WTRU may transmit a further S-SS/PSBCH transmission on the second frequency in the second beam direction.

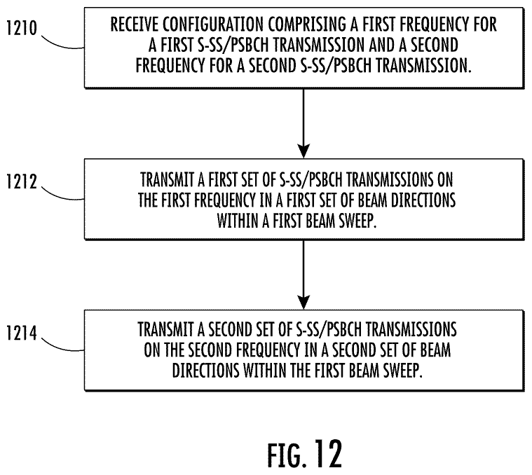

FIG. 12 is a flow chart for an exemplary embodiment for transmission of S-SS/PSBCH by a WTRU. At 1210, a WTRU may receive a configuration comprising a first frequency for a first S-SS/PSBCH transmission and a second frequency for a second S-SS/PSBCH transmission. At 1212, the WTRU may transmit a first set of S-SS/PSBCH transmissions on the first frequency in a first set of beam directions within a first beam sweep. At 1214 the WTRU may transmit a second set of S-SS/PSBCH transmissions on the second frequency in a second set of beam directions within the first beam sweep.

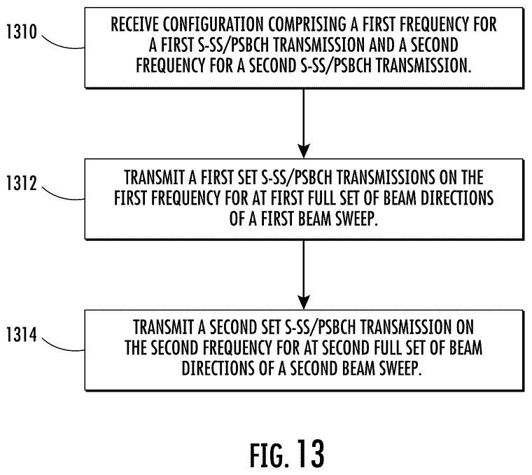

FIG. 13 is a flow chart for an exemplary embodiment for transmission of S-SS/PSBCH by a WTRU. At 1310, a WTRU may receive a configuration comprising a first frequency for a first S-SS/PSBCH transmission and a second frequency for a second S-SS/PSBCH transmission. At 1312, the WTRU may transmit a first set S-SS/PSBCH transmissions on the first frequency for a first full set of beam directions of a first beam sweep. At 1314, the WTRU may transmit a second set S-SS/PSBCH transmission on the second frequency for a second full set of beam directions of a second beam sweep.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a WTRU comprising:
receiving configuration information comprising at least a first frequency for a first sidelink synchronization signal/physical sidelink broadcast channel (S-SS/PSBCH) transmission and a second frequency for a second S-SS/PSBCH transmission;
monitoring for reception of the first S-SS/PSBCH transmission on the first frequency at a first time; and
monitoring for reception of the second S-SS/PSBCH transmission on the second frequency at a second time.

2. The method of claim 1, wherein the configuration information is received during a radio resource control (RRC) configuration or a system information message.

3. The method of claim 1, wherein the first time and the second time are within a single S-SSB transmission period.

4. The method of claim 1, wherein the first time and the second time occur during sequential S-SSB transmission periods.

5. A method performed by a WTRU comprising:
receiving configuration information comprising at least a first frequency for a first S-SS/PSBCH transmission and a second frequency for a second S-SS/PSBCH transmission;
transmitting a first S-SS/PSBCH transmission on the first frequency at a first time; and
transmitting the second S-SS/PSBCH transmission on the second frequency at a second time.

6. The method of claim 5, wherein the configuration information is received during a RRC configuration or a system information message.

7. The method of claim 5, wherein the first time and the second time are within a single S-SSB transmission period.

8. The method of claim 5, wherein the first time and the second time occur during sequential S-SSB transmission periods.

9. The method of claim 5, wherein the WTRU performs beam sweeping comprising a plurality of beam directions and wherein the first S-SS/PSBCH transmission and the second S-SS/PSBCH transmission are made in a first beam direction, and every subsequent two S-SS/PSBCH transmissions are made in the first and second frequencies per each remaining beam direction within a beam sweep.

10. The method of claim 5, wherein the WTRU performs beam sweeping comprising a plurality of beam directions and wherein the first S-SS/PSBCH transmission is made in a first set of the beam directions of a first sweep through the plurality of beam directions and wherein the second S-SS/PSBCH transmission is made in a second set of beam directions of the first sweep through the plurality of beam directions.

11. The method of claim 5, wherein the WTRU performs beam sweeping comprising a plurality of beam directions and wherein the first S-SS/PSBCH transmission is made at each of the beam directions of a first set of sweeps through the plurality of beam directions and wherein the second S-SS/PSBCH transmission is made at each of the beam directions of a second set of sweeps through the plurality of beam directions.

12. A WTRU comprising:
a processor and
a transceiver, wherein
the processor is configured to receive configuration information comprising at least a first frequency for a first S-SS/PSBCH transmission and a second frequency for a second S-SS/PSBCH transmission.

13. The WTRU of claim 12, wherein
the transceiver is configured to monitor for reception of the first S-SS/PSBCH transmission on the first frequency at a first time, and
to monitor for reception of the second S-SS/PSBCH transmission on the second frequency at a second time.

14. The WTRU of claim 13, wherein the first time and the second time are within a single S-SSB transmission period.

15. The WTRU of claim 13, wherein the first time and the second time occur during sequential S-SSB transmission periods.

16. The WTRU of claim 12, wherein
the transceiver is configured to transmit the first S-SS/PSBCH transmission on the first frequency at a first time, and
to transmit the second S-SS/PSBCH transmission on the second frequency at a second time.

17. The WTRU of claim 16, wherein the first time and the second time are within a single S-SSB transmission period or wherein the first time and the second time occur during sequential S-SSB transmission periods.

18. The WTRU of claim 16, wherein the transceiver is configured to perform beam sweeping comprising a plurality of beam directions and the transceiver is further configured to perform the first S-SS/PSBCH transmission and the second S-SS/PSBCH transmission in a first beam direction, and every subsequent two S-SS/PSBCH transmissions are made in the first and second frequencies per each remaining beam direction within a beam sweep.

19. The WTRU of claim 16, wherein the transceiver is configured to perform beam sweeping comprising a plurality of beam directions and the transceiver is further configured to perform the first S-SS/PSBCH transmission in a first set of the beam directions of a first sweep through the plurality of beam directions and to perform the second S-SS/PSBCH transmission is made in a second set of beam directions of the first sweep through the plurality of beam directions.

20. The WTRU of claim 16, wherein the transceiver is configured to perform beam sweeping comprising a plurality of beam directions and wherein the transceiver is further configured to perform the first S-SS/PSBCH transmission in each of the beam directions of a first set of sweeps through the plurality of beam directions and to perform the second S-SS/PSBCH transmission in each of the beam directions of a second set of sweeps through the plurality of beam directions.
